(19) United States
(12) Patent Application Publication
(10) Pub. No.: US 2008/0231899 A1
(43) Pub. Date: Sep. 25, 2008

(54) Image forming system, portable communication device, recording medium and image formation method

(75) Inventor: Atsuhisa Morimoto, Nara-shi (JP)

Correspondence Address: Edwards Angell Palmer & Dodge LLP, P.O. Box 55874, Boston, MA, 02205, US

(73) Assignee: Sharp Kabushiki Kaisha, Osaka (JP)

(21) Appl. No.: 12/077,840

(22) Filed: Mar. 21, 2008

(30) Foreign Application Priority Data
Mar. 23, 2007 (JP) 2007-077413

(51) Int. Cl. G06K 15/00; G06F 15/00

(52) U.S. Cl. 358/1.15

(57) ABSTRACT

When printing a file stored in a PC by a digital multi-function peripheral specified by a user, a portable terminal device transmits a print request to the PC, calculates a total time of processing time between the portable terminal device and PC and processing time between the PC and digital multi-function peripheral as an estimated print time, and displays the estimated print time.

### CROSS-REFERENCE TO RELATED APPLICATION

This non-provisional application claims priority under 35 U.S.C. §119(a) on Patent Application No. 2007-077413 filed in Japan on Mar. 23, 2007, the entire contents of which are hereby incorporated by reference.

### BACKGROUND

1. Technical Field

The present invention relates to an image forming system for forming an image by an image forming apparatus, based on image data stored in a communication device, upon an image formation request from a portable communication device; a portable communication device constituting the image forming system; a recording medium storing a computer program for realizing the portable communication device; and an image formation method.

2. Description of Related Art

In recent years, with high speed information processing represented by the Internet or an increase in the amount of information, digital multi-function peripherals having a scanner function, a printer function, a facsimile function, an electronic mail function etc., or facsimile machines, are connected to user information terminal devices such as personal computers in remote locations through networks or communication lines, and shared by a large number of users. There has been utilized a system which uses such networks or communication lines to select a file stored in a personal computer installed in an office from a portable terminal device (mobile terminal device), such as a notebook type personal computer or a PDA, in a location outside the office and prints the selected file with a digital multi-function peripheral installed in the location outside the office.

For example, a print management server device is connected to such a network or a communication line, a list of information about output terminal devices (for example, multi-function peripherals) connected to the print management server device is received by a cell phone or a user terminal device (such as a personal computer or a workstation), an output terminal device is selected using the cell phone or the user terminal device, and a file to be printed is transmitted to the print management server device. The print management server device converts the received print data into print data of a format capable of being outputted by the selected output terminal device, and transmits the converted print data to the specified output terminal device. Further, there is proposed a print management server device in which, when an instruction to print the print data is given from the cell phone or the user terminal device, the print management server device specifies an output terminal device to store the print data corresponding to the print instruction, and controls printing for the specified output terminal device (see Japanese Patent Application Laid-Open No. 2004-213370).

### SUMMARY

However, in the example of Japanese Patent Application Laid-Open No. 2004-213370, since a print management server device is required, the entire cost of the system rises. Moreover, since it is necessary to transmit the print data in advance to the print management server device, if the user forgets to transmit the print data, there is a problem that he or she can not promptly obtain the prints. Further, in the conventional system, since a print request and print data are transmitted through networks or communication lines, if it needs a long time to perform printing after making a print request, the user has to wait until printing without knowing what time printing is performed, and therefore there is a demand for improving convenience for users.

With the aim of solving the above problems, and it is an object to provide an image forming system capable of improving convenience for users by calculating a time required from the time of transmission of an image formation request from a portable communication device to the time of image formation and outputting the required time when forming an image by an image forming apparatus based on image data stored in a communication device, and to provide a portable communication device constituting the image forming system, a recording medium storing a computer program for realizing the portable communication device, and an image formation method.

An image forming system according to a first aspect is an image forming system comprising: a communication device for storing image data; and a portable communication device and an image forming apparatus connected to the communication device through a communication network, wherein the image forming apparatus includes: storing means for storing specific information; and forming means for forming an image based on image data transmitted from the communication device, the portable communication device includes: obtaining means for obtaining specific information from the image forming apparatus; selecting means for selecting image data for image formation from the image data stored in the communication device; and transmitting means for transmitting an image formation request for the image data selected by the selecting means and the specific information obtained by the obtaining means to the communication device; calculating means for calculating a time required from the time of transmission of the image formation request to the time of image formation; and output means for outputting the required time calculated by the calculating means, and the image data selected by the selecting means is transmitted from the communication device to the image forming apparatus corresponding to the specific information, according to the image formation request from the portable communication device, and an image is formed in the image forming apparatus based on the selected image data.

An image forming system according to a second aspect is characterized in that the portable communication device includes: first calculating means for calculating a first time period from the time of transmission of the image formation request to the time of reception of the image formation request in the communication device; and second calculating means for calculating a second time period from the time of transmission of selected image data to the time of image formation in the image forming apparatus, and the calculating means calculates the required time, based on the first time period and second time period calculated by the first calculating means and second calculating means.

An image forming system according to a third aspect is characterized in that the communication device receives an image formation request and specific information transmitted from the portable communication device through a mail server connected to the communication network, and the first calculating means calculates the first time period based on a time interval of accessing the mail server and a data transfer rate of the communication network.

An image forming system according to a fourth aspect is characterized in that the image forming apparatus receives the image data transmitted from the communication device through a mail server connected to the communication network, and the second calculating means calculates a second time period based on a time interval of accessing the mail server and a data transfer rate of the communication network.

An image forming system according to a fifth aspect is characterized in that the portable communication device further includes: setting means for setting a secure printing process which requires an input of predetermined authentication information in the image forming apparatus when forming an image, and, when the secure printing process is set by the setting means, the calculating means calculates a time period from the time of transmission of the image formation request to a time point at which the image forming apparatus becomes ready for image formation corresponding to the image formation request.

A portable communication device according to a sixth aspect is a portable communication device for transmitting an image formation request for formation of an image based on image data, comprising: obtaining means for obtaining specific information about an image forming apparatus; selecting means for selecting image data for image formation from image data; transmitting means for transmitting an image formation request for the image data selected by the selecting means and the specific information obtained by the obtaining means; calculating means for calculating a time required from the time of transmission of the image formation request to the time of image formation; and output means for outputting the required time calculated by the calculating means.

A recording medium readable by a computer and storing a computer program according to a seventh aspect is a recording medium readable by a computer and storing a computer program for causing a computer to transmit an image formation request for formation of an image based on image data, the computer program comprising: a step of causing the computer to determine image data for image formation according to an external operation; and a step of causing the computer to calculate a time required from the time of transmission of an image formation request for the determined image data to the time of image formation.

An image formation method according to an eighth aspect is an image formation method, by connecting a portable communication device and an image forming apparatus to a communication device storing image data through a communication network, for forming an image with the image forming apparatus, based on image data stored in the communication device, upon an image formation request from the portable communication device, comprising the steps of the image forming apparatus storing specific information in advance; the portable communication device obtaining specific information from the image forming apparatus; the portable communication device determining image data for image formation from the image data stored in the communication device according to an external operation; the portable communication device transmitting an image formation request for the determined image data and the obtained specific information to the communication device; the portable communication device calculating a time required from the time of transmission of the image formation request to the time of image formation; the portable communication device outputting the calculated required time; the communication device receiving the image formation request and the specific information; the communication device transmitting the determined image data to the image forming apparatus corresponding to the received specific information; the image forming apparatus receiving the image data; and the image forming apparatus forming an image based on the received image data.

In the first, sixth, seventh and eighth aspects, a portable communication device (for example, a mobile communication device such as a cell phone and a PDA) carried by a user obtains specific information (such as, for example, an electronic mail address, a public key, a print function, POP time of a mail server, and a transfer rate of a communication line) about an image forming apparatus (for example, a digital multi-function peripheral). The portable communication device obtains a list of image data stored in a communication device (such as, for example, a personal computer or a workstation) from the communication device, selects image data for image formation (for example, printing) from the image data, and transmits an image formation request for the selected image data and the obtained specific information (for example, the electronic mail address of the image forming apparatus) to the communication device. The portable communication device calculates a time required from the time of transmission of the image formation request to the time of image formation (for example, a time required from a time point at which the image formation request is transmitted to a time point at which image formation is ready to be performed, or a time required from a time point at which the image formation request is transmitted to a time point at which image formation is completed) and outputs the required time. The communication device receives the image formation request and specific information transmitted from the portable communication device and transmits the selected image data to the image forming apparatus corresponding to the received specific information. The image forming apparatus receives the image data and forms an image based on the received image data. Thus, since the user who transmitted the image formation request from the portable communication device is able to know the time required until the image formation is performed, he or she can do another work during the waiting time and can also promptly collect prints with the formed images, and convenience and the security level are improved.

In the second aspect, the portable communication device calculates the first time period from the time of transmission of the image formation request to the time of reception of the image formation request in the communication device, and calculates the second time period from the time of transmission of the selected image data to the time of image formation in the image forming apparatus (such as, for example, to a time point at which image formation is completed or a time point at which image formation is ready to be performed). The portable communication device calculates the required time based on the calculated first time period and second time period. For example, the portable communication device calculates a total time of the first time period and the second time period as the required time. It is thus possible to calculate the required time by taking into account the processing time between the portable communication device and communication device and the processing time between the communication device and image forming apparatus.

In the third aspect, the portable communication device calculates the first time period based on the time interval of accessing the mail server, for example, POP (Post Office Protocol) time when the communication device receives the image formation request and specific information, and the transfer rate (data transfer rate) of the communication network to which the communication device is connected. Therefore, even when the image formation request and specific information are transmitted and received through electronic mails, it is possible to relatively accurately calculate a time required for communication between the portable communication device and the communication device.

In the fourth aspect, the portable communication device calculates the second time period based on the time interval of accessing the mail server (for example, POP time) when the image forming apparatus receives the image data, and the transfer rate (data transfer rate) of the communication network to which the image forming apparatus is connected. Therefore, even when the image data are transmitted and received through electronic mails, it is possible to relatively accurately calculate a time required for communication between the communication device and the image forming apparatus.

In the fifth aspect, when a secure process (for example, secure printing process) which requires an input of predetermined authentication information in the image forming apparatus when forming an image is set, the portable communication device calculates a time period from the time of transmission of the image formation request to a time point at which the image forming apparatus becomes ready for image formation corresponding to the image formation request as the required time. Thus, when performing the secure printing process, the user is able to know the time taken for the image forming apparatus to be ready for image formation after making an image formation request, and it is possible to timely obtain the prints by reducing useless waiting time.

According to the first, sixth, seventh and eighth aspects, the user who transmitted an image formation request from the portable communication device is able to know the time taken until the image formation is performed, he or she can do another work during the waiting time and can also promptly collect prints with the formed images, and convenience and the security level are improved.

According to the second aspect, it is possible to calculate the required time by taking into account the processing time between the portable communication device and communication device connected through the communication network and the processing time between the communication device and image forming apparatus connected through the communication network.

According to the third aspect, even when an image formation request and specific information are transmitted and received through electronic mails, it is possible to relatively accurately calculate the time required for communication.

According to the fourth aspect, even when image data are transmitted and received through electronic mails, it is possible to relatively accurately calculate the time required for communication.

According to the fifth aspect, when performing the secure printing process, the user is able to know the time taken for the image forming apparatus to be ready for image formation after making an image formation request, and it is possible to timely obtain the prints by reducing useless waiting time.

The above and further objects and features will more fully be apparent from the following detailed description with accompanying drawings.

### BRIEF DESCRIPTION OF THE SEVERAL VIEWS OF THE DRAWINGS

FIG. 1 is a schematic view showing the structure of an image forming system;

FIG. 2 is a block diagram showing the structure of a digital multi-function peripheral;

FIG. 3 is a block diagram showing the structure of a portable terminal device;

FIG. 4 is an explanatory view showing an example of calculating an estimated print time;

FIG. 5 is a flowchart showing the processing steps performed by a portable terminal device;

FIG. 6 is a flowchart showing the processing steps performed by a PC; and

FIG. 7 is a flowchart showing the processing steps performed by a digital multi-function peripheral.

### DETAILED DESCRIPTION

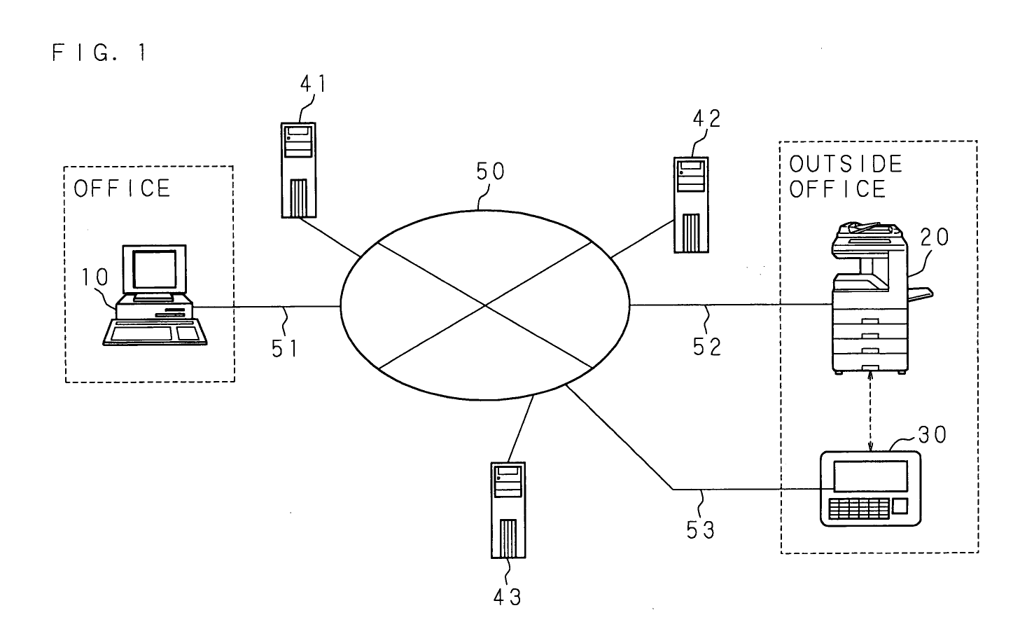

The following description will explain an image forming system based on the drawings illustrating an embodiment thereof. FIG. 1 is a schematic view showing the structure of the image forming system. As shown in FIG. 1, the image forming system comprises a personal computer or a workstation (hereinafter referred to as the PC) 10 (communication device) installed in an office where a user usually works (hereinafter referred to as the office); a digital multi-function peripheral 20 (image forming apparatus) installed in an office in a different location where the user visits (hereinafter referred to as the outside office); and a portable terminal device 30 (portable communication device), such as a notebook type personal computer, a cell phone or a PDA, carried by the user. The PC, digital multi-function peripheral 20, portable terminal device 30 are connected to a communication network including communication lines 51, 52, 53 and the Internet 50.

The PC 10 is connected to the Internet 50 through the communication line 51; the digital multi-function peripheral 20 is connected to the Internet 50 through the communication line 52; and the portable terminal device 30 is connected to the Internet 50 through the communication line 53. Moreover, mail servers 41, 42 and 43 are connected to the Internet 50 so that the PC 10 receives electronic mails via the mail server 41, the digital multi-function peripheral 20 receives electronic mails via the mail server 42, and the mobile terminals 30 receives electronic mails via the mail server 43.

The PC 10 comprises a main unit including a microprocessor, a memory and a HDD; a display section; a keyboard; and a mouse, and stores, for example, image data created or used by the user (such as, for example, pamphlets, catalogs, reference materials for meetings, proceedings, and customer information) in a file format. Further, the PC 10 stores PC information such as POP (Post Office Protocol) time (set to 1 minute, for example) which is the time interval of accessing the mail server 41 and the transfer rate (data transfer rate) of the communication line 51.

Every time the set POP time passes, the PC 10 accesses the mail server 41 and checks whether or not there are electronic mails transmitted to the PC 10, and, if an electronic mail is present in the mail server 41, receives the electronic mail from the mail server 41. For example, as to be described later, the PC 10 receives from the portable terminal device 30 transmission requests for a file list of image data stored in a file format (such as the file name, file size, directory, author, and date created), PC information etc., and a print request for printing a desired file by a specified digital multi-function peripheral 20.

Moreover, as to be described later, when the PC 10 receives from the portable terminal device 30 a print request for printing a stored file by a digital multi-function peripheral 20 specified by the user, it converts the file to be printed into a file format (for example, print data such as PDF and JPEG) capable of being processed by the digital multi-function peripheral 20, encrypts the converted print data by a predetermined encryption method (for example, triple DES), and transmits the encrypted print data to the digital multi-function peripheral 20 by attaching it to an electronic mail. Further, when the print data is encrypted, the PC 10 transmits the size of the encrypted print data to the portable terminal device 30. When the PC 10 receives transmission requests for a file list, PC information etc., it transmits the file list, PC information etc. to the portable terminal device 30.

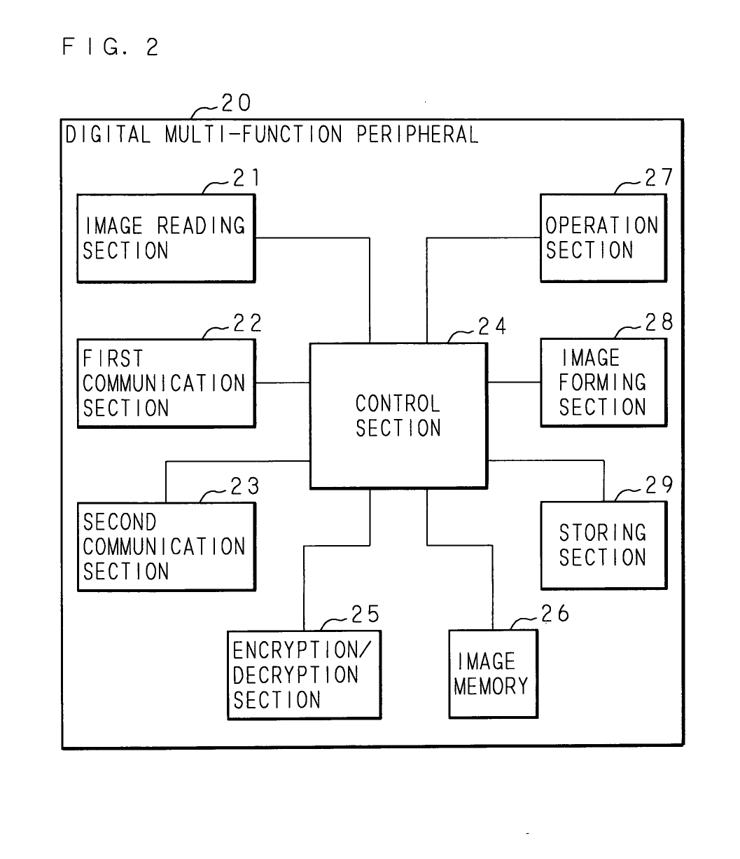

FIG. 2 is a block diagram showing the structure of a digital multi-function peripheral 20. The digital multi-function peripheral 20 comprises an image reading section 21, a first communication section 22, a second communication section 23, a control section 24, an encryption and decryption section 25, an image memory 26, an operation section 27, an image forming section 28, and a storing section 29, and has a plurality of functions, such as a facsimile function, a copy function, a printer function, a scanner function and an electronic mail function.

The image reading section 21 is an automatic document feeder (ADF) including a CCD and a document sensor, has a scanner function, detects a document placed on a document tray with the document sensor, irradiates light onto the document moving along a transport path for transporting a document, photo-electrically converts the reflected light from the document into image data by the CCD, and stores the image data in the image memory 26.

The control section 24 comprises a CPU, a ROM and a RAM, and controls the entire processes performed by the digital multi-function peripheral 20. When keeping the image data stored in the image memory 26, the control section 24 encrypts the image data read from the image memory 26 in the encryption and decryption section 25, and stores the encrypted image data in the storing section 29. When forming an image based on the image data stored in the image memory 26, the control section 24 performs an editing process, such as a density conversion process and a magnification conversion process, on the image data read from the image memory 26, and outputs the processed image data to the image forming section 28.

The first communication section 22 has a communication function for communicating with the PC 10 through the communication line 52 and the Internet 50. For example, the first communication section 22 is able to communicate through a LAN cable, or using a wireless technique based on either of wireless LAN standards IEEE802.11a, IEEE802.11b, and IEEE802.11g.

Under the control of the control section 24, the first communication section 22 accesses the mail server 42 every time the set POP time passes, checks whether or not there are electronic mails transmitted to the digital multi-function peripheral 20, and, if an electronic mail is present in the mail server 42, receives the electronic mail from the mail server 42. For example, the first communication section 22 receives print data, print conditions (for example, the number of copies to be printed, paper size, paper type, whether or not a secure printing process is selected) etc. from the PC 10. The first communication section 22 outputs the received print data to the encryption and description section 25.

The encryption and decryption section 25 decrypts the print data inputted from the first communication section 22 by a predetermined method (for example, triple DES), temporarily stores the decrypted print data in the image memory 26 if necessary, and then outputs it to the image forming section 28.

The image forming section 28 has a printer function, and forms an image on paper based on the inputted print data and discharges the paper with the image formed thereon. For example, the image forming section 28 comprises a photosensitive drum, a charger for charging the photosensitive drum to a predetermined electric potential, a laser write device for forming an electrostatic latent image on the photosensitive drum surface, a developing device for visualizing the electrostatic latent image on the photosensitive drum surface into a toner image by supplying toner, and a transfer device for transferring the toner image on the photosensitive drum surface to paper (none of them are shown). Note that the image forming section 28 is not limited to an electrophotographic type, and can be of any type, such as inkjet type and heat transfer type.

The storing section 29 stores MFP (Multi Function Peripherals) information (specific information), such as the POP (Pose Office Protocol) time (set to one minute, for example) as the time interval of accessing the mail server 42, the transfer rate of the communication line 52, an electronic mail address of the digital multi-function peripheral 20, a public key (or a password of each user), print function information (for example, color/monochrome printing, paper size, paper type, print speed, presence or absence of double-side print function, resolution, and a file format capable of being outputted).

The second communication section 23 has a wired data communication function using serial data transfer or parallel data transfer based on USB (Universal Serial Bus) standards or IEEE 1394 standards, or a wireless data communication function using Bluetooth, infrared communication, and communication using a non-contact IC, and is capable of performing data communication with the portable terminal device 30. For example, the second communication section 23 transmits the MFP information to the portable terminal device 30 based on a request from the portable terminal device 30.

The operation section 27 is a touch panel type operation panel, for example, and comprises an input section for receiving operation instructions from a user, and a display section composed of a liquid crystal display for displaying various types of information to the user. For example, when secure printing is set for a file to be printed, the operation section 27 displays a message requesting the user to input a public key (or a password for authenticating each user) under the control of the control section 24, and outputs the inputted public key or password to the control section 24 when the user inputs the public key or password. Note that the control section 24 authenticates the inputted public key or password and determines whether or not to allow secure printing, based on the authentication result.

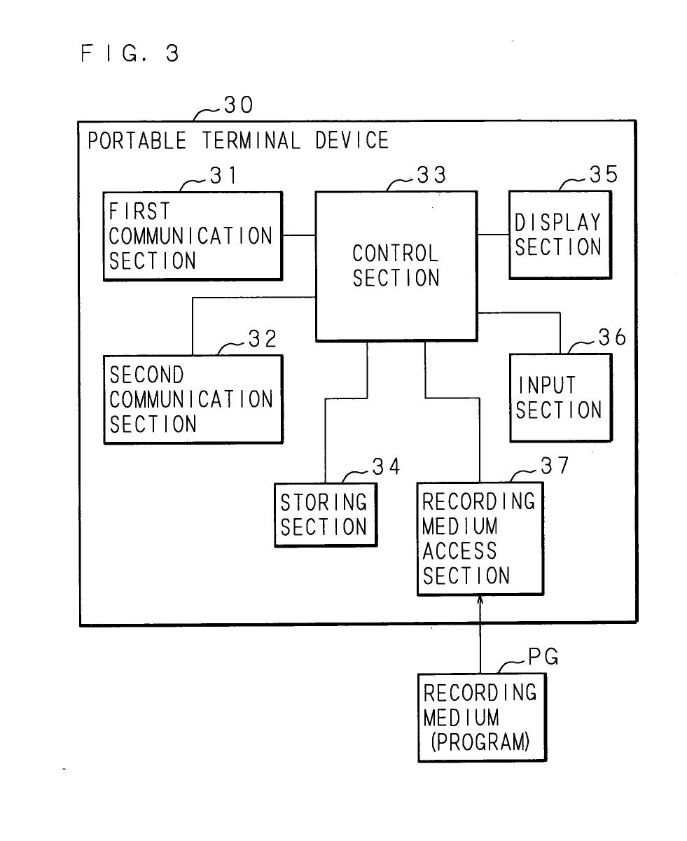

FIG. 3 is a block diagram showing the structure of a portable terminal device 30. The portable terminal device 30 comprises a first communication section 31, a second communication section 32, a control section 33, a storing section 34, a display section 35, an input section 36, and a recording medium access section 37.

The first communication section 31 has a communication function to communicate with the PC 10 through the communication line 53 and the Internet 50. For example, the first communication section 31 is able to communicate through a LAN cable, or using a wireless technique based on either of IEEE 802.11a, IEEE 803.11lb and IEEE802.11g as standards for wireless LANs.

Under the control of the control section 33, the first communication section 31 (transmitting means) transmits requests (transmission requests) for a file list of image data stored in the PC 10, PC information etc. The first communication section 31 receives the file list, PC information etc. transmitted from the PC 10. The first communication section 31 also transmits to the PC 10 a print request for printing a file selected from the received file list by the user.

When a print request is transmitted, the information, such as the file selected by the user, the MFP information (for example, an electronic mail address) of a digital multi-function peripheral 20 specified as a print location by the user, and print conditions (the number of copies to be printed, paper size, whether or not double-side printing is to be performed, whether or not secure printing is to be performed, etc.), are transmitted together with the print request.

Moreover, when the print data is encrypted by the PC 10, the first communication section 31 receives the size of the encrypted print data from the PC 10.

The second communication section 32 has a wired data communication function using serial data transfer or parallel data transfer based on USB (Universal Serial Bus) standards or IEEE 1394 standards, or a wireless data communication function using Bluetooth, infrared communication, and communication using a non-contact IC, and is capable of performing data communication with the digital multi-function peripheral 20. For example, the second communication section 23 transmits a request for the MFP information to the digital multi-function peripheral 20, and receives the MFP information from the digital multi-function peripheral 20.

The storing section 34 stores POP (Post Office Protocol) time (for example, set to one minute) as the time interval of accessing the mail server 43 and the transfer rate of the communication line 53. Moreover, the storing section 34 stores the MFP information obtained from the digital multi-function peripheral 20, the PC information obtained from the PC 10, and the size of the encrypted print data.

Further, the storing section 34 stores a processing time table which relates the size of print data with the data conversion processing time, encryption processing time, and decryption processing time for print data.

The display section 35 (output means) is a liquid crystal display, for example, and displays information necessary for selecting a file to be printed from the image data stored in the PC 10 and printing it by the digital multi-function peripheral 20 under the control of the control section 33. In addition, the display section 35 displays an estimated print time from the time point at which the print request was made until printing is performed.

The input section 36 (selecting means, setting means) includes, for example, various types of keys and buttons, selects a file to be printed from the image data stored in the PC 10, receives an input of information necessary for printing in the digital multi-function peripheral 20, and outputs the received input to the control section 33 under the control of the control section 33. For example, the user is able to specify a digital multi-function peripheral 20 in a print location, select a file to be printed, and set print conditions etc. from the input section 36.

The control section 33 (obtaining means, calculating means, first calculating means, second calculating means) includes a microprocessor, a RAM, and a ROM, and controls the operation of the portable terminal device 30. The control section 33 calculates an estimated print time from a time point at which the user made a print request until printing is performed, and outputs the calculated estimated print time to the display section 35. Note that the operation of the control section 33 can be carried out by loading a program PG which defines the operation steps into the RAM and executing the program PG by the CPU.

The recording medium access section 37 is a CD-ROM drive, a DVD drive, an IC card drive, a semiconductor memory drive or the like, and reads the program PG recorded on a recording medium and outputs it to the control section 33.

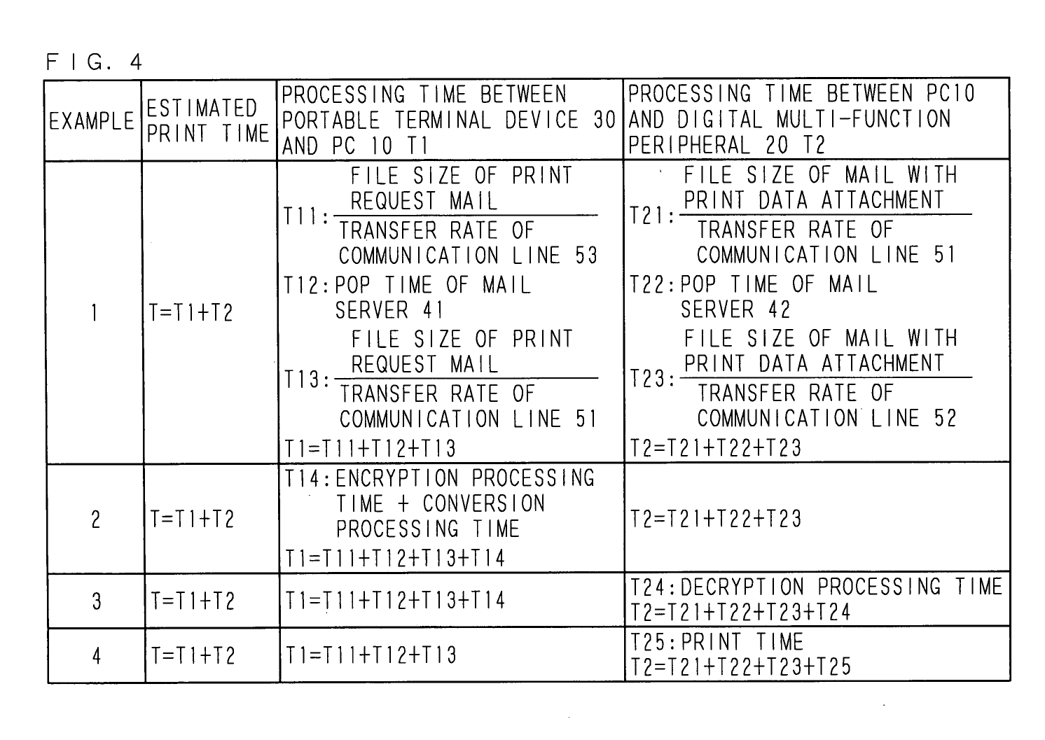

FIG. 4 is an explanatory view showing an example of calculating an estimated print time T. The estimated print time T is calculated as a total time of processing time T1 between the portable terminal device 30 and PC 10 and processing time T2 between the PC 10 and digital multi-function peripheral 20.

As shown in FIG. 4, in Example 1, the processing time T1 between the portable terminal device 30 and the PC 10 is calculated by T1=T11+T12+T13. In this case, T11 is the communication processing time in the communication line 53 and can be calculated as T11=(the size of print request mail/the transfer rate of the communication line 53). T12 can be calculated as the POP time of the mail server 41. T13 is the communication processing time in the communication line 51 and can be calculated as T13=(the size of print request mail/the transfer rate of the communication line 51).

The processing time T2 between the PC 10 and the digital multi-function peripheral 20 is calculated by T2=T21+T22+T23. In this case, T21 is the communication processing time in the communication line 51 and can be calculated as T21=(the size of mail with print data attachment/the transfer rate of the communication line 51). T22 can be calculated as the POP time of the mail server 42. T23 is the communication processing time in the communication line 52 and can be calculated as T23=(the size of mail with print data attachment/the transfer rate of the communication line 52).

In Example 2, the processing time T1 between the portable terminal device 30 and the PC 10 is calculated by T1=T11+T12+T13+T14. In this case, T14 is the total time of the conversion processing time for converting the print data into data capable of being processed by the digital multi-function peripheral 20 and the encryption processing time for encrypting the converted print data in the PC 10. The processing time T2 between the PC 10 and the digital-multi-function peripheral 20 is calculated by T2=T21+T22+T23.

In Example 3, the processing time T1 between the portable terminal device 30 and the PC 10 is calculated by T1=T11+T12+T13+T14. The processing time T2 between the PC 10 and the digital multi-function peripheral 20 is calculated by T2=T21+T22+T23+T24. In this case, T24 is the decryption processing time for decrypting the encrypted print data in the digital multi-function peripheral 20.

In Example 4, the processing time T1 between the portable terminal device 30 and the PC 10 is calculated by T1=T11+T12+T13. The processing time T2 between the PC 10 and the digital multi-function peripheral 20 is calculated by T2=T21+T22+T23+T25. In this case, T25 is the time from a time point at which the digital multi-function peripheral 20 becomes a printable state to a time point at which printing is completed, that is, the print time. For example, the print time can be calculated by multiplying the print speed per page in the digital multi-function peripheral 20 by the number of copies to be printed.

The calculation of estimated print time T is merely an example and is not limited to Examples 1 to 4. For instance, in Example 4, the processing time T1 between the portable terminal device 30 and the PC 10 may be calculated by T1=T11+T12+T13+T14. It may also be possible to calculate the processing time T2 between the PC 10 and the digital multi-function peripheral 20 by T2=T21+T22+T23+T24+T25. When secure printing is set, the estimated print time T may be calculated as in Examples 1 to 3, whereas when secure printing is not set, the estimated print time T may be calculated as in Example 4 including the print time.

The transfer rates of the respective communication lines 51, 52 and 53 may be set in advance. However, it may be possible to store program codes for measuring the transfer rates of the communication lines in the PC 10 and the digital multi-function peripheral 20 and measure the transfer rates at predetermined time points or time intervals. Moreover, it is possible to use a statistical value (the average value, median value, minimum value or the like) based on the results of measurements performed a plurality of times.

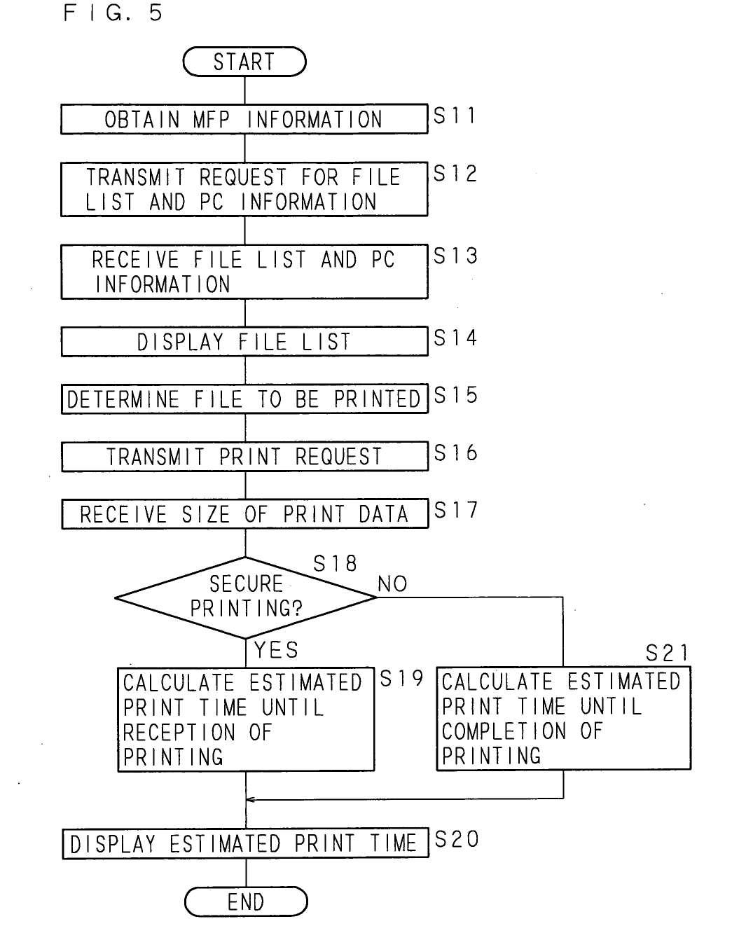

Next, the operation of the image forming system will be explained. FIG. 5 is a flowchart showing the processing steps performed by the portable terminal device 30. The control section 33 obtains the MFP information about a digital multi-function peripheral 20 specified by a user in the outside office (S11). For example, the control section 33 transmits a request for a file list stored in a PC 10 that the user uses in the office and the PC information to the PC 10 (S12).

The control section 33 receives the file list and PC information transmitted from the PC 10 (S13), and displays the received file list in the display section 35 (S14). When an operation allowing the user to select a desired file from the file list displayed in the display section 35 is received in the input section 36, the control section 33 determines a file to be printed (S15) and transmits a print request with a print request mail to the PC 10 (S16). In this case, the user can set through the input section 36 as to whether or not to perform secure printing.

The control section 33 receives the size of encrypted print data transmitted from the PC 10 (S17). When the file list transmitted in advance from the PC 10 includes the print data size (the encrypted file and print instructing mail size), the control section 33 executes the process of step S18 without receiving the size of the encrypted print data transmitted from the PC 10. The control section 33 determines whether or not the print process is secure printing according to the user settings (S18), and, if secure printing is set (YES in S18), calculates an estimated print time T until reception of printing in the digital multi-function peripheral 20 (S19). In this case, as the estimated print time T to be calculated, it is possible to use any one of the times given in Examples 1 to 3 explained with reference to FIG. 4.

The control section 33 displays the calculated estimated print time T in the display section 35 (S20) and completes the process. On the other hand, if secure printing is not set (NO in S18), the control section 33 calculates an estimated print time T until completion of printing in the digital multi-function peripheral 20 (S21) and executes the process of step S20. In this case, as the estimated print time T to be calculated, it is possible to use the time given in Example 4 explained with reference to FIG. 4.

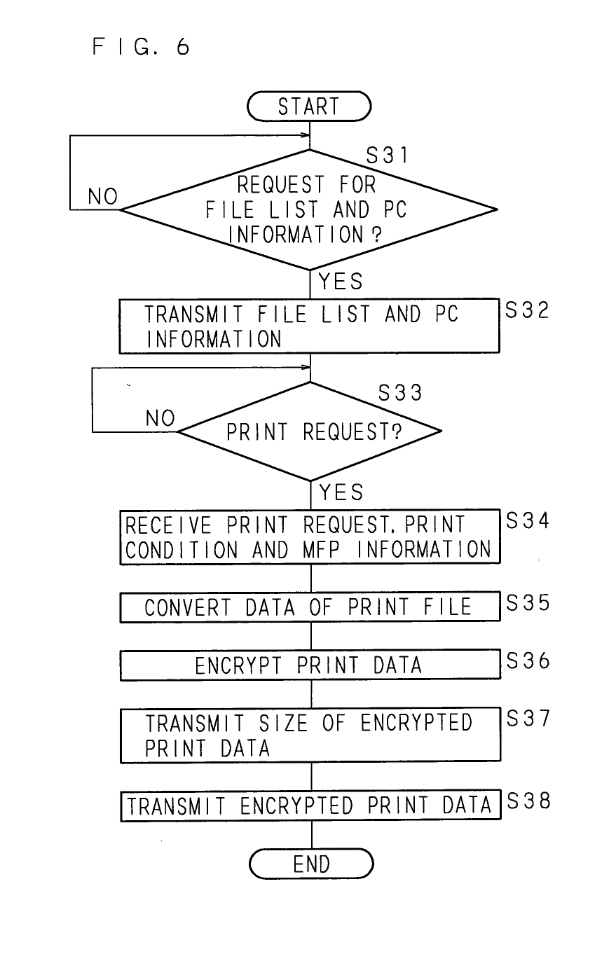

FIG. 6 is a flowchart showing the processing steps performed by the PC 10. The PC 10 checks whether or not there is a request for a file list and PC information (S31). If there is no request (NO in S31), the PC 10 continues the process of step S31 and waits until a request is made. If there is a request (YES in S31), the PC 10 transmits the file list and PC information to the portable terminal device 30 (S32).

The PC 10 checks whether or not there is a print request (print request mail) transmitted from the portable terminal device 30 (S33). If there is no print request (NO in S33), the PC 10 continues the process of step S33 and waits until a print request is made. If there is a print request (YES in S33), the PC 10 receives the print request, print conditions and MFP information (S34), and performs a data conversion process for converting a file (print file) determined to be printed by the portable terminal device 30 into a printable file format (S35).

The PC 10 encrypts the data-converted print data (S36), and transmits the size of the encrypted print data to the portable terminal device 30 (S37). The PC 10 transmits the encrypted print data to the electronic mail address contained in the MFP information, that is, the digital multi-function peripheral 20 specified by the user (S38), and completes the process. Note that print conditions, such as the number of copies to be printed, paper size, whether or not double-side printing is set and whether or not secure printing is set, are transmitted together with the print data.

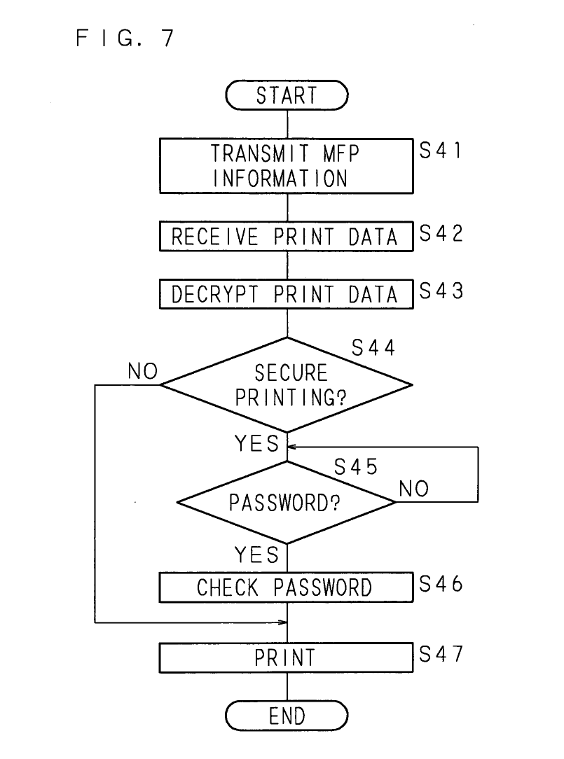

FIG. 7 is a flowchart showing the processing steps performed by the digital multi-function peripheral 20. The control section 24 transmits the MFP information to the portable terminal device 30 upon a request from the portable terminal device 30 (S41).

The control section 24 receives the print data from the PC 10 (S42), and decrypts the received print data (S43). The control section 24 determines whether or not secure printing is set (S44). If secure printing is set (YES in S44), the control section 24 determines whether or not a password is received in the operation section 27 (S45). If the password is not received (NO in S45), the control section 24 continues the process of step S45 and waits until the password is received.

When the password is received (YES in S45), the control section 24 authenticates the password by determining whether or not the received password matches the password stored in advance (S46). After authenticating the password, the control section 24 performs printing based on-the print conditions (S47) and finishes the process. Note that when the authentication of the password is not performed, the control section 24 is able to output warning and finish the process. When secure printing is not set (NO in S44), the control section 24 performs the process of step S47.

As explained above, since the user who transmitted a print request (image formation request) from the portable terminal device 30 is able to know the estimated print time until printing is performed, he or she can perform another work during the waiting time and promptly collect the prints, and convenience and the security level are improved. Moreover, it is possible to calculate the estimated print time by taking into account the processing time between the portable terminal device 30 and the PC 10 connected through the communication network and the processing time between the PC 10 and the digital multi-function peripheral 20 connected through the communication network. Further, even when transmitting or receiving a print request and print data through an electronic mail, it is possible to relatively accurately calculate the time required for communication. In addition, when performing secure printing, the user is able to know the time taken for the digital multi-function peripheral 20 to move into a printable state after a print request is made, and it is possible to timely obtain the prints by reducing useless waiting time.

In the above-described embodiment, although one PC 10, one digital multi-function peripheral 20 and one portable terminal device 30 are connected through the communication network, the number of the PCs 10, digital multi-function peripherals 20 and portable terminal devices 30 is not limited to one, and it may be possible to provide a plurality of PCs 10, digital multi-function peripherals 20 and portable terminal devices 30.

In the above-described embodiment, the digital multi-function peripheral 20 is explained as one example. However, the application of the image forming system is not limited to the digital multi-function peripheral 20, and, for example, it is possible to apply the image forming system to apparatuses, such as facsimile machines having a communication function, and printers having a network communication function.

Although the above-described embodiment illustrates the structure where the mail servers 41, 42 and 43 are connected to the Internet 50, the number of the mail servers is not limited to this and may vary according to the number of PCs 10 installed in the office and the number of digital multi-function peripherals 20 installed in the outside office. It may also be possible to integrate the mail servers 42 and 43 into one mail server. The POP times in the respective mail servers may be set to values desired for the PC 10, the digital multi-function peripheral 20 and the portable terminal device 30, respectively.

In addition, it is possible to record program codes (execution type program, intermediate code program, source program) of a computer program for performing the above-described process of calculating an estimated print time on a computer-readable recording medium storing a computer program to be executed by a computer. As a result, it is possible to provide a portable recording medium storing a computer program for performing the above-mentioned process. The recording medium may be program media such as a memory, not shown, for example, a ROM, to perform the process by a micro computer, or program media capable of being read by inserting the recording media into a program reader provided as an external storage device, not shown.

In either case, the stored computer program codes may be accessed and executed by the micro processor, or it may be possible to read the computer program codes, download the read computer program codes into a program storing area, not shown, of the micro computer, and execute the computer program. In this case, the computer program to be downloaded is stored in the main unit in advance.

Here, the program media are recording media designed to be removable from the main unit, and may be media carrying computer program codes in a fixed manner, including tapes such as magnetic tapes and cassette tapes; disks including magnetic disks, such as a flexible disk and a hard disk, and optical disks such as a CD-ROM, MO, MD, and DVD; cards such as IC cards (including memory cards) and optical cards; or semiconductor memory such as a mask ROM, EPROM (Erasable Programmable Read Only Memory), EEPROM (Electrically Erasable Programmable Read Only Memory), and flash ROM.

In this case, since the system is constructed to be connectable to communication networks including the Internet, the recording medium may carry a computer program in a movable manner such as by downloading computer program codes from a communication network. If the computer program code is to be downloaded from the communication network as described above, the computer program to be downloaded may be stored in the main unit in advance, or may be installed from another recording medium. This may also be realized in a form in which the program code is embodied by electronic transfer of a computer data signal embedded in a carrier wave.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. An image forming system comprising:
a communication device for storing image data; and
a portable communication device and an image forming apparatus connected to said communication device through a communication network, wherein
said image forming apparatus includes:
a storing section for storing specific information; and
an image forming section for forming an image based on image data transmitted from said communication device,
said portable communication device includes:
a controller for obtaining specific information from said image forming apparatus;
a selecting section for selecting image data for image formation from the image data stored in said communication device; and
a transmitting section for transmitting an image formation request for the image data selected by said selecting section and the specific information obtained by said controller to said communication device,
said controller calculates a time required from time of transmission of the image formation request to time of image formation, and
said portable communication device further includes: an output section for outputting the required time calculated by said controller, and
the image data selected by said selecting section is transmitted from said communication device to the image forming apparatus corresponding to the specific information, according to the image formation request from said portable communication device, and an image is formed in said image forming apparatus based on the selected image data.

2. The image forming system according to claim 1, wherein said controller calculates a first time period from time of transmission of the image formation request to time of reception of the image formation request in said communication device;
calculates a second time period from time of transmission of the selected image data to time of image formation in said image forming apparatus; and
calculates the required time based on the calculated first time period and second time period.

3. The image forming system according to claim 2, wherein said communication device receives an image formation request and specific information transmitted from said portable communication device through a mail server connected to the communication network, and
said controller calculates the first time period based on a time interval of accessing the mail server and a data transfer rate of the communication network.

4. The image forming system according to claim 2, wherein said image forming apparatus receives the image data transmitted from said communication device through a mail server connected to the communication network, and
said controller calculates the second time period based on a time interval of accessing the mail server and a data transfer rate of the communication network.

5. The image forming system according to claim 1, wherein said portable communication device further includes a setting section for setting a secure printing process which requires an input of predetermined authentication information in said image forming apparatus when forming an image, and
when the secure printing process is set in said setting section, said controller calculates a time period from time of transmission of the image formation request to a time point at which said image forming apparatus becomes ready to form an image corresponding to the image formation request.

6. An image forming system comprising:
a communication device for storing image data; and
a portable communication device and an image forming apparatus connected to said communication device through a communication network, wherein
said image forming apparatus includes:
storing means for storing specific information; and
forming means for forming an image based on image data transmitted from said communication device,
said portable communication device includes:
obtaining means for obtaining specific information from said image forming apparatus;
selecting means for selecting image data for image formation from the image data stored in said communication device; and
transmitting means for transmitting an image formation request for the image data selected by said selecting means and the specific information obtained by said obtaining means to said communication device;
calculating means for calculating a time required from time of transmission of the image formation request to time of image formation; and
output means for outputting the required time calculated by said calculating means, and
the image data selected by said selecting means is transmitted from said communication device to the image forming apparatus corresponding to the specific information, according to the image formation request from said portable communication device, and an image is formed in said image forming apparatus based on the selected image data.

7. The image forming system according to claim 6, wherein said portable communication device includes:
first calculating means for calculating a first time period from time of transmission of the image formation request to time of reception of the image formation request in said communication device; and
second calculating means for calculating a second time period from time of transmission of selected image data to time of image formation in said image forming apparatus, and
said calculating means calculates the required time based on the first time period and second time period calculated by said first calculating means and second calculating means.

8. The image forming system according to claim 7, wherein said communication device receives an image formation request and specific information transmitted from said portable communication device through a mail server connected to the communication network, and
said first calculating means calculates the first time period based on a time interval of accessing the mail server and a data transfer rate of the communication network.

9. The image forming system according to claim 7, wherein said image forming apparatus receives the image data transmitted from said communication device through a mail server connected to the communication network, and
said second calculating means calculates the second time period based on a time interval of accessing the mail server and a data transfer rate of the communication network.

10. The image forming system according to claim 6, wherein said portable communication device further includes: setting means for setting a secure printing process which requires an input of predetermined authentication information in said image forming apparatus when forming an image, and
when the secure printing process is set in said setting means, said calculating means calculates a time period from time of transmission of the image formation request to a time point at which said image forming apparatus becomes ready to form an image corresponding to the image formation request.

11. A portable communication device for transmitting an image formation request for formation of an image based on image data, comprising:
a controller for obtaining specific information about an image forming apparatus;
a selecting section for selecting image data for image formation from image data; and
a transmitting section for transmitting an image formation request for the image data selected by said selecting section and the specific information obtained by said controller, wherein
said controller calculates a time required from time of transmission of the image formation request to time of image formation, and
said portable communication device further comprises an output section for outputting the required time calculated by said controller.

12. A portable communication device for transmitting an image formation request for formation of an image based on image data, comprising:
obtaining means for obtaining specific information about an image forming apparatus;
selecting means for selecting image data for image formation from image data;.
transmitting means for transmitting an image formation request for the image data selected by said selecting means and the specific information obtained by said obtaining means;
calculating means for calculating a time required from time of transmission of the image formation request to time of image formation; and
output means for outputting the required time calculated by said calculating means.

13. A recording medium readable by a computer and storing a computer program for causing a computer to transmit an image formation request for formation of an image based on image data, said computer program comprising:
a step of causing the computer to determine image data for image formation according to an external operation; and
a step of causing the computer to calculate a time required from time of transmission of an image formation request for the determined image data to time of image formation.

14. An image formation method, by connecting a portable communication device and an image forming apparatus to a communication device storing image data through a communication network, for forming an image with the image forming apparatus, based on image data stored in the communication device, upon an image formation request from the portable communication device, comprising the steps of:
said image forming apparatus storing specific information in advance;
said portable communication device obtaining specific information from said image forming apparatus;
said portable communication device determining image data for image formation from the image data stored in said communication device according to an external operation;
said portable communication device transmitting an image formation request for the determined image data and the obtained specific information to said communication device;
said portable communication device calculating a time required from time of transmission of the image formation request to time of image formation;
said portable communication device outputting the calculated required time;
said communication device receiving the image formation request and specific information;
said communication device transmitting the determined image data to the image forming apparatus corresponding to the received specific information;
said image forming apparatus receiving the image data; and
said image forming apparatus forming an image based on the received image data.
